(19) United States
(12) Patent Application Publication
(10) Pub. No.: US 2010/0015280 A1
(43) Pub. Date: Jan. 21, 2010

(54) Functional No-Trans Oils With Modulated Omega-6 To Omega-3 Ratio

(76) Inventors: Lawrence Paul Klemann, Annandale, NJ (US); Thomas Michael Richar, Long Valley, NJ (US)

Correspondence Address: FITCH EVEN TABIN & FLANNERY, 120 SOUTH LASALLE STREET, SUITE 1600, CHICAGO, IL, 60603-3406, US

(21) Appl. No.: 12/504,805

(22) Filed: Jul. 17, 2009

Related U.S. Application Data
(60) Provisional application No. 61/082,411, filed on Jul. 21, 2008.

(51) Int. Cl. A23D 9/00; A23D 9/04; A23D 9/02; A21D 2/00

(52) U.S. Cl. 426/33; 426/417; 426/601; 426/549

(57) ABSTRACT

The functional oils provided herein are formulated for low saturated fat content, rapid crystallization, no trans content, high alpha-linolenic acid (ALA), and a specific ratio of omega-6 (linoleic; C18:2) to omega-3 (alpha-linolenic; C18:3) acids. The functional oils provided herein are formulated with liquid vegetable oil and concentrated saturated fatty acid fraction, where the concentrated saturated fatty acid fraction is derived principally from interesterified blends of liquid oil and fully hydrogenated vegetable oil. The unique ensemble of desirable functional and nutritional properties has not previously been simultaneously formulated into lipid compositions suitable for shortening and spray oil applications.

This application claims priority to U.S. Provisional Application No. 61/082,411, filed Jul. 21, 2008, which is incorporated by reference herein in its entirety.

### FIELD OF THE INVENTION

The functional oils provided herein are formulated for low saturated fat content, rapid crystallization, no trans content, high alpha-linolenic acid (ALA), and a specific ratio of omega-6 (linoleic; C18:2) to omega-3 (alpha-linolenic; C18:3) acids. The unique ensemble of desirable functional and nutritional properties has not previously been simultaneously formulated into lipid compositions suitable for shortening and spray oil applications.

### BACKGROUND OF THE INVENTION

The consumer demand for trans fat free food products has increased recently due to public awareness of the health risks of dietary fat. This is especially true with baked items, which often contain relatively high levels of fat which contribute to their appetizing taste, flavor, and appearance.

Legislation to require declaration of trans-fat in foods has stimulated activity in the edible oil and processed food industries to identify low and no-trans replacements for partially hydrogenated oils. To compensate for the solid forming capacity lost as partially hydrogenated fat is reduced or eliminated, blends of liquid oils with saturated fat rich palm oil fractions have emerged as a quick and easy solution. U.S. Pat. No. 5,843,497 describes blends of high linoleic acid (C18:2) content oils with palm oil (both in broad weight percentage ranges) as a means to improve blood plasma ratios of LDL and HDL cholesterol. In control experiments carried out by the inventors, the levels of saturated fat required to deliver critical functionality have been found to be excessively high using reasonable blends of these liquid-solid fractions.

Recent trends in low and no-trans oils have focused on various approaches to increase oleic acid and reduce alpha-linolenic acid content to enhance oxidative stability. This trend has resulted in oils with high ratios of omega-6 (linoleic acid) to omega-3 (linolenic acid). For example, NuSun® high oleic sunflower oil and “low-lin” soybean oil have omega-6/omega-3 ratios of about 26 and about 18, respectively. The blending of such oils with palm oil-derived hardstock fractions has little effect on these undesirably high ratios of omega-6 to omega-3 acids. The prior art has not recognized the negative nutritional impact of high C18:2 content possible and very probable in such blend compositions. The problem solved by the invention described herein has never been adequately addressed in the art.

### SUMMARY

Functional oils are provided herein that are virtually trans-fat free (i.e., less than 1.5 percent) while simultaneously delivering omega-6 and omega-3 polyunsaturated fatty acids at or below a ratio of 10, a ratio that is generally regarded by nutritionists as desirable from a health standpoint.

The functional oils described herein further advantageously derive maximum functionality (as measured by solid fat content vs. temperature, and by crystallization velocity) with a conservative saturated fat content (e.g., less than about 32 percent), where less than about 16 percent of C12:0, C14:0, and C16:0 saturated fatty acids are derived from tropical oils (e.g., palm, coconut, and palm kernel oil), while simultaneously providing a minimum of 6 percent alpha-linolenic acid. The functional oils described herein also provide an excellent and nutritionally desirable ratio of omega-6 to omega-3 fatty acids of less than 10.

The functional oils provided herein are formulated with liquid vegetable oil and concentrated saturated fatty acid fraction (“SFAF” or “hardstock”), where the SFAF is derived principally from interesterified blends of liquid oil and fully hydrogenated vegetable oil. The SFAF fraction is prepared by combining liquid vegetable oil and fully hydrogenated vegetable oil at a ratio of about 70:30 to about 40:60, preferably at a ratio of about 65:35 to about 45:55, and more preferably in a ratio of about 60:40 to about 50:50. Enzymatic or chemical interesterification methods can be used.

Diluent liquid oil is blended with the SFAF at a ratio of about 40:60 to about 75:25, preferably at a ratio of about 50:50 to about 70:30, and more preferably at a ratio of about 60:40 to provide the functional no-trans oils of the invention.

The liquid vegetable oils and fully hydrogenated vegetable oils used to prepare the functional no-trans oils of the invention should be selected so as to provide functional oils having the following characteristics: 1) low weight percent of total saturated fatty acids, such as less than about 32 percent, preferably less than about 25 percent; 2) a minor contribution of tropical oil-derived saturated fatty acids; preferably, the sum of total C12:0, C14:0, C16:0 saturated fatty acids derived from tropical oils is less than about 16 percent; 3) a final blend of liquid oil and SFAF that includes greater than 6 percent alpha-linolenic acid content; and 4) a final blend of liquid oil and SFAF that delivers a ratio of linoleic acid (C18:2) to alpha-linolenic acid (C18:3) less than 10, preferably less than 7, and more preferably less than 4.

### BRIEF DESCRIPTION OF THE DRAWINGS

FIG. 1 is a graph showing the solid fat content curves of the control and experimental samples of Example 1.

FIG. 2 is a graph showing the solid fat content curves of the control and experimental samples of Example 6.

FIG. 3 is a graph showing the crystallization curves (percent solids over time) when the control and experimental samples of Example 6 are heated to 60° C. and cooled to 21.1° C.

FIG. 4 is a graph showing the solid fat content curves of the control and experimental samples of Example 7.

FIG. 5 is a graph showing the crystallization curves (percent solids over time) when the control and experimental samples of Example 7 are heated to 60° C. and cooled to 21.1° C.

FIG. 6 is a graph showing the crystallization curves (percent solids over time) when the control and experimental samples of Example 10 are heated to 60° C. and cooled to 26.7° C.

FIG. 7(a)-(c) are graphs showing the crystallization curves (percent solids over time) when the control and experimental samples of Example 11 are heated to 60° C. and cooled to 15.6° C. (FIG. 7(a)), 21.1° C. (FIG. 7(b)), or 26.7° C. (FIG. 7(c)).

### DETAILED DESCRIPTION

Functional oils (i.e., oils that have solid fat content from triglycerides enriched in saturated C18:0 fatty acids) have never been formulated to be virtually trans-fat free while simultaneously delivering omega-6 and omega-3 polyunsaturated fatty acids at or below a ratio of 10, a ratio that is generally regarded by nutritionists as desirable from a health standpoint. As defined herein, “no trans fat” or equivalent phrases means less than about 1.5 percent trans-fatty acids.

The functional oils described herein further advantageously derive maximum functionality (as measured by solid fat content vs. temperature, and by crystallization velocity) with a conservative saturated fat content (e.g., less than about 32 percent), where less than about 16 percent of C12:0, C14:0, and C16:0 saturated fatty acids are derived from tropical oils (e.g., palm, coconut, and palm kernel oil), while simultaneously providing a minimum of 6 percent alpha-linolenic acid. The functional oils described herein also provide an excellent and nutritionally desirable ratio of C18:2 and C18:3 fatty acids of less than 10. The prior art has consistently overlooked the need to maintain adequate levels of alpha-linolenic acid (an essential fatty acid) in the edible oil.

The functional oils provided herein are formulated with liquid vegetable oil and concentrated saturated fatty acid fraction (“SFAF” or “hardstock”), where the SFAF is derived principally from interesterified blends of liquid oil and fully hydrogenated vegetable oil.

The SFAF fraction is prepared by combining liquid vegetable oil and fully hydrogenated vegetable oil at a ratio of about 70:30 to about 40:60, preferably at a ratio of about 65:35 to about 45:55, and more preferably in a ratio of about 60:40 to about 50:50. Virtually any liquid oil and any fully hydrogenated oil can be used for interesterification. All unsaturated fatty acids are converted to saturated fatty acids by complete hydrogenation. The ratio of the two oils is most important in maximizing functionality while minimizing the saturated fat that provides this functionality. The SFAF fraction concentrates functional, saturated fatty acid-containing triacylglycerols, which serves to minimize the required level of saturated fat. By selection of the ratio of liquid oil to fully hydrogenated oil, interesterification can be used to create a maximum weight fraction of functional triacylglycerols (i.e., those having two saturated fatty acids and one unsaturated fatty acid), while achieving a balance that carries a functionally useful level of trisaturated glycerol esters and a minimum of poorly functional triacylglycerols (i.e., those having one saturated fatty acid and two unsaturated fatty acids).

The resulting oil mixture is then interesterified. Interesterification reactions are utilized to rearrange the fatty acid residues within and between the triglycerides, thus altering the physical and nutritional properties of the resulting products. Procedures for interesterification are well known to those skilled in the art. See, e.g., U.S. Pat. No. 5,380,544 (Mar. 5, 1993), U.S. Pat. No. 5,662,953 (Sep. 2, 1997), and U.S. Pat. No. 6,277,432 (Aug. 21, 2001), which are incorporated herein by reference. Interesterification reactions may be catalyzed chemically or enzymatically. Chemical interesterification can be carried out by combining the fully hydrogenated oil and liquid oil components, warming the mixture to between about 100 to about 120° C. under vacuum to remove traces of water, and adding about 0.5 to about 1.0 weight percent catalyst, such as anhydrous sodium methoxide. Generally, strong bases, such as sodium methoxide or sodium-potassium alloy or potassium ethoxide, and the like, are used to catalyze the interesterification reaction. The mixture is stirred and, typically within about five minutes, develops a reddish brown color indicating formation of the catalytically active species. After about 1 to about 3 hours, the mixture is cooled to below 100° C., and about 5 percent water is added to deactivate the catalyst. Bleaching clay (approximately 5 percent by weight of the initial reactants) is then added, and the mixture is stirred under vacuum for about 15 to about 30 minutes followed by vacuum filtration. The filtrate solidifies on cooling and is used as a hardstock component.

Enzyme catalyzed interesterification reactions typically employ about 0.34 grams of immobilized enzyme per gram of total triglyceride substrate (i.e., fully hydrogenated vegetable oil plus liquid oil). Suitable enzymes generally belong to the broad category of lipases that catalyze the interchange of fatty acids located at the terminal or 1,3-glycerol position of different triacylglycerols, such as Lipozyme RM IM from Novo Nordisk A/S. The enzyme and substrate mixture is placed in a suitably sized, single neck vacuum flask which is fitted to a vacuum rotary evaporator. A solvent (such as hexane) may be used to ensure that the fully hydrogenated vegetable component of the reaction mixture is completely melted and dissolved at an incubation temperature of about 45° C. Vacuum is applied to secure the flask which is rotated at about 175 rpm. The mixture can be sampled periodically and the oil phase can be analyzed to assess the progress of the reaction. A variety of analyses, such as high performance liquid chromatography, thin layer chromatography, high temperature capillary gas chromatography, and the like) are useful for monitoring conversion of reactants to products. When the reaction has proceeded to the desired state (typically to equilibrium or steady state, nominally about 8 to 24 hours) vacuum is released and the contents of the flask are vacuum filtered to separate the immobilized catalyst. If a solvent has been employed, the filtrate may be returned to another vacuum flask and stripped on the vacuum rotary evaporator. The final product may be vacuum steam deodorized to remove all traces of solvent and free fatty acids. The interesterified SFAF compositions are solids at room temperature and are useful as hardstocks in blends with liquid oil.

It was surprisingly found that comparable reactant mixtures gave different levels of higher melting solids depending on whether chemical or enzymatic interesterification was used. The final SFAF composition generally included more higher melting solids when the enzyme catalyst was used compared to when chemical catalysts were used.

After interesterification, the SFAF is diluted by blending with liquid vegetable oil. Once the oils used for the hardstock have been selected, the choice of diluent liquid oil and ratio for blending with the hardstock is more significant. The liquid oil used to dilute the hardstock must be selected to provide the final ratio of omega-6 to omega-3 of about 10, less than 1.5 percent trans-fat, and reduced levels of non-functional saturated fat. To achieve a ratio of omega-6 to omega-3 fatty acids near the optimal level (e.g., about 2-3), the linolenic and linoleic acids content of the vegetable oil should be taken into consideration. Preferably, the liquid oil is also rich in oleic acid, which contributes to ingredient stability over the shelf life of the final food product. Soybean and canola oils are preferred as both are relatively inexpensive and are readily available. Also preferred are enhanced seed oils with fatty acid profiles that mimic those of canola oil, such as, for example, high oleic soybean oil.

The liquid vegetable oils and fully hydrogenated vegetable oils used to prepare the functional no-trans oils of the invention should be selected so as to provide functional oils having the following characteristics: 1) low weight percent of total saturated fatty acids, such as less than about 32 percent, preferably less than about 25 percent; 2) a minor contribution of tropical oil-derived saturated fatty acids; preferably, the sum of total C12:0, C14:0, C16:0 saturated fatty acids derived from tropical oils is less than about 16 percent; 3) a final blend of liquid oil and SFAF that includes greater than 6 percent alpha-linolenic acid content; and 4) a final blend of liquid oil and SFAF that delivers a ratio of linoleic acid (C18:2) to alpha-linolenic acid (C18:3) less than 10, preferably less than 7, and more preferably less than 4. The functional oils provided herein also have modulated crystallization velocity. Therefore, various liquid vegetable oils and fully hydrogenated vegetable oils may be selected so long as the final product has the desired characteristics described above. For example, a liquid oil may be selected that has a ratio of linoleic acid to alpha-linolenic acid of greater than 10 as long as the selected fully hydrogenated vegetable oil has a ratio sufficiently low so as to provide a final product having a ratio of linoleic acid to alpha-linolenic acid of less than 10. Preferred oils include soybean oil, canola oil, high oleic soybean oil, olive oil, and grapeseed oil.

The ratio of diluent oil to SFAF is also important because sufficient SFAF is needed to deliver the required amount of functionality for use with a particular product or product category. Generally, diluent liquid oil is blended with the SFAF at a ratio of about 40:60 to about 75:25, preferably at a ratio of about 50:50 to about 70:30, and more preferably at a ratio of about 60:40. It has been found that other ratios of liquid vegetable oil to SFAF are suitable for a variety of food applications. When the final product application is baked items such as cookies and crackers, a shortening or spray oil comprised of about 60 percent liquid oil and about 40 percent interesterified SFAF is particularly advantageous. Similar products can also be successfully produced with “lighter” liquid-to-solid blends, such as 70:30 or even 90:10 (although the mobility of oil in these products will be increased as the solid component in the final blend is decreased). It should be noted that, while a major advantage of the functional oils described herein is the minimum saturated fat content, compositions substantially enriched in the hardstock component are also valuable. For example, if an application in a product such as a puffed pastry is desired, then a liquid-to-solid blend substantially enriched in the solid component, such as about 30:70 to about 5:95, can be beneficial.

The functional low-trans oils provide a conservative amount of saturated fat, preferably less than about 32 percent, more preferably less than about 25 percent, and with limited saturated fat content being derived from tropical sources. The sum of C12:0, C14:0, and C16:0 saturated fatty acids derived from tropical oils should be less than 16 percent.

The functional low-trans oils of the invention can also have a modulated crystallization velocity. Solidification of the fat is important in establishing the requisite precursor structure in dough prior to baking and also for holding ingredients on the surface of crackers when used as a spray shortening.

The functional low-trans oils of the invention can be provided in the form of a shortening or spray oil, among other forms, if desired.

The following examples illustrate methods for carrying out the invention and should be understood to be illustrative of, but not limiting upon, the scope of the invention which is defined in the appended claims.

### EXAMPLES

The abbreviations used in the examples are as follows: Low Trans Blend #1 (LTB#1), soybean oil (SBO), canola oil (CAN), fully hydrogenated soybean oil (FHSBO), fully hydrogenated cottonseed oil (FHCSO), chemical interesterification (CIE), enzymatic interesterification (EIE), and solid fat content (SFC). LTB#1 is a control product which includes 78 percent liquid soybean oil (SBO) and 22 percent partially hydrogenated cottonseed oil (PHCSO). LTB#1 contains 24 percent saturates and 8 percent trans fat, bringing the total (saturates+trans) to nearly 32 percent. Lipid ingredients used for the following experiments include liquid soybean oil (SBO), liquid canola oil (CAN), fully hydrogenated soybean oil (FHSBO), and fully hydrogenated palm oil (FHPO). The two methods used to produce hardstock blends are chemical interesterification (CIE) and enzymatic interesterification (EIE).

### Example 1

Initially, four SFAF (“hardstock”) blends were created by mixing 60:40 (liquid:solid) ratio blends of either soybean oil or canola oil with fully hydrogenated soybean oil and subjecting the mixtures to either chemical interesterification or enzymatic interesterification. An outside vendor completed the interesterification reactions. While the exact conditions used in the interesterification reactions are not known, suitable interesterification processes are described below which could be used to obtain the desired hardstock component.

Chemical interesterification is carried out by combining the fully hydrogenated oil and liquid oil components, warming this mixture to between about 100 to about 120° C. under vacuum to remove traces of water, and adding about 0.5 to about 1.0 weight percent anhydrous sodium methoxide. The mixture is stirred and, typically within about five minutes, develops a reddish brown color indicating formation of the catalytically active species. After about 1 to about 3 hours, the mixture is cooled to below 100° C., and about 5 percent water is added to deactivate the catalyst. Bleaching clay (approximately 5 percent by weight of the initial reactants) is then added, and the mixture is stirred under vacuum for about 15 to about 30 minutes followed by vacuum filtration. The filtrate solidifies on cooling and is used as a hardstock component.

Enzyme catalyzed interesterification reactions typically employ 0.34 grams of immobilized enzyme (Novo Lipozyme RM IM) per gram of total triglyceride substrate (i.e., fully hydrogenated vegetable oil plus liquid oil). The enzyme and substrate mixture is placed in a suitably sized, single neck vacuum flask fitted to a vacuum rotary evaporator. A solvent (such as hexane) may be used to ensure that the fully hydrogenated vegetable component of the reaction mixture is completely melted and dissolved at an incubation temperature of about 45° C. Vacuum is applied to secure the flask, which is rotated at 175 rpm. The mixture can be sampled periodically and the oil phase can be analyzed to assess the progress of the reaction. A variety of analyses (High Performance Liquid Chromatography, thin layer chromatography, High Temperature Capillary Gas Chromatography, and the like) can be used for monitoring conversion of reactants to products. When the reaction has proceeded to the desired state (typically to equilibrium or steady state, nominally about 8 to about 24 hours), vacuum is released and the contents of the flask are vacuum filtered to separate the immobilized catalyst. If a solvent has been employed, the filtrate is transferred to another vacuum flask and stripped on the vacuum rotary evaporator. The final product may be vacuum steam deodorized to remove all traces of solvent and free fatty acids. The interesterified compositions are solids at room temperature.

The fatty acid profiles of the hardstock blends are presented below in Table 1. The fatty acid profiles were determined using AOCS method Ce1-62, which is hereby incorporated by reference in its entirety.

TABLE 1

| | |
|---|---|
| 60% liquid | 60% liquid |
| soybean | canola |
| oil:40% fully | oil:40% fully |
| hydrogenated | hydrogenated |
| soybean oil | soybean oil |

| | CIE | EIE | CIE | EIE |
|---|---|---|---|---|
| Fatty Acid | Actual | Actual | Actual | Actual |
| C12:0 | 0.1 | 0.0 | 0.1 | 0.0 |
| C14:0 | 0.1 | 0.1 | 0.1 | 0.7 |
| C16:0 | 11.0 | 10.8 | 7.5 | 7.2 |
| Total | 11.2 | 10.9 | 7.7 | 7.9 |
| C12:0-C16:0 | | | | |
| C18:0 | 37.2 | 35.7 | 35.8 | 35.4 |
| C18:1 t | 0.0 | 0.5 | 0.1 | 0.6 |
| C18:1 c | 13.2 | 14.7 | 35.7 | 37.0 |
| Total C18:1 | 13.2 | 15.2 | 35.8 | 37.6 |
| C18:2 t | 0.1 | 0.3 | 0.1 | 0.1 |
| C18:2 c | 32.4 | 32.5 | 12.6 | 12.1 |
| Total C18:2 | 32.5 | 32.8 | 12.7 | 12.2 |
| C18:3 t | 0.2 | 0.5 | 0.2 | 0.3 |
| C18:3 c | 4.3 | 3.2 | 5.2 | 4.7 |
| Total C18:3 | 4.5 | 3.7 | 5.3 | 5.0 |
| sats | 49.5 | 47.9 | 45.1 | 44.0 |
| monos | 13.2 | 15.2 | 35.8 | 37.6 |
| polys | 37.0 | 36.5 | 18.0 | 17.2 |
| trans | 0.4 | 1.3 | 0.4 | 0.9 |
| SFC Temp | SFC | SFC | SFC | SFC |
| 0.0° C. (32° F.) | 50.3 | 42.6 | 40.9 | 39.8 |
| 10.0° C. (50° F.) | 35.1 | 33.1 | 30.5 | 39.2 |
| 15.6° C. (60° F.) | 31.6 | 36.0 | 35.0 | 43.9 |
| 21.1° C. (70° F.) | 33.0 | 39.4 | 34.1 | 39.4 |
| 26.7° C. (80° F.) | 27.2 | 32.9 | 24.2 | 31.8 |
| 33.3° C. (92° F.) | 16.1 | 24.5 | 14.1 | 22.8 |
| 37.8° C. | 11.6 | 19.5 | 9.6 | 18.4 |
| (100° F.) | | | | |
| 40.0° C. | 9.1 | 17.8 | 7.5 | 15.6 |
| (104° F.) | | | | |
| 42.5° C. | 7.2 | 15.0 | 6.4 | 13.5 |
| (109° F.) | | | | |
| 45.0° C. | 5.1 | 12.6 | 5.1 | 11.0 |
| (113° F.) | | | | |
| 47.5° C. | 2.8 | 11.5 | 4.2 | 9.4 |
| (118° F.) | | | | |
| 50.0° C. | 2.0 | 9.0 | 2.6 | 6.8 |
| (122° F.) | | | | |
| 52.5° C. | 0.8 | 7.7 | 1.6 | 5.1 |
| (127° F.) | | | | |
| 55.0° C. | 0.0 | 5.0 | 0.0 | 3.3 |
| (131° F.) | | | | |
| 57.5° C. | | 3.4 | | 0.8 |
| (136° F.) | | | | |
| 60.0° C. | | 1.6 | | 0.0 |
| (140° F.) | | | | |
| 62.5° C. | | 0.0 | | |
| (145° F.) | | | | |

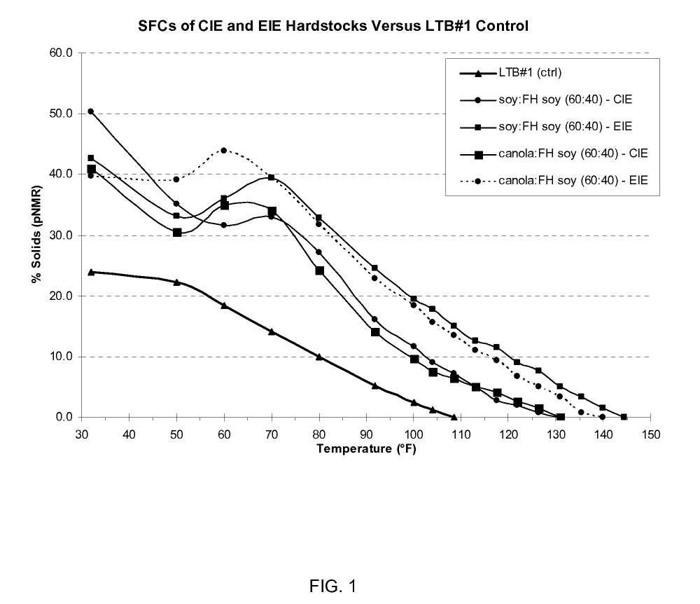

The solid fat content (SFC) of the interesterified products was determined using AOCS Method Cd 16b-93, which is incorporated herein by reference in its entirety. It was surprisingly found that the same two components (liquid soybean oil and fully hydrogenated soybean oil) that were blended in the same ratio and had nearly identical fatty acid profiles gave different SFC profiles depending on whether they were produced using CIE or EIE. As shown in Table 2 below and in FIG. 1, the EIE samples contained more higher-melting solid components than the CIE samples. To bring these hardstocks into the appropriate saturate range (comparable to LTB#1) they were diluted using either liquid soybean oil or liquid canola oil as described in Examples 2-5.

TABLE 2
Solid Fat Content

| | | SBO:FHSBO | SBO:FHSBO | CAN:FHSBO | CAN:FHSBO |
|---|---|---|---|---|---|
| | | (60:40) | (60:40) | (60:40) | (60:40) |
| ° C. | LTB#1 (ctrl) | CIE | EIE | CIE | EIE |
| 0.0 | 23.9 | 50.3 | 42.6 | 40.9 | 39.8 |
| 10.0 | 22.3 | 35.1 | 33.1 | 30.5 | 39.2 |
| 15.6 | 18.4 | 31.6 | 36.0 | 35.0 | 43.9 |
| 21.1 | 14.1 | 33.0 | 39.4 | 34.1 | 39.4 |
| 26.7 | 10.0 | 27.2 | 32.9 | 24.2 | 31.8 |
| 33.3 | 5.2 | 16.1 | 24.5 | 14.1 | 22.8 |
| 37.8 | 2.4 | 11.6 | 19.5 | 9.6 | 18.4 |
| 40.0 | 1.2 | 9.1 | 17.8 | 7.5 | 15.6 |
| 42.5 | 0.0 | 7.2 | 15.0 | 6.4 | 13.5 |
| 45.0 | | 5.1 | 12.6 | 5.1 | 11.0 |
| 47.5 | | 2.8 | 11.5 | 4.2 | 9.4 |
| 50.0 | | 2.0 | 9.0 | 2.6 | 6.8 |
| 52.5 | | 0.8 | 7.7 | 1.6 | 5.1 |
| 55.0 | | 0.0 | 5.0 | 0.0 | 3.3 |
| 57.5 | | | 3.4 | | 0.8 |
| 60.0 | | | 1.6 | | 0.0 |
| 62.5 | | | 0.0 | | |

### Example 2

The 60% soybean oil: 40% fully hydrogenated soybean oil chemically interesterified hardstock of Example 1 was diluted with either liquid soybean oil or liquid canola oil as follows: 50:50 (liquid:hardstock), 60:40 (liquid:hardstock), and 70:30 (liquid:hardstock). The fatty acid profile and SFC data were measured as described in Example 1 and the data is shown in Table 3 below.

TABLE 3

| | Hardstock = 60% soybean oil:40% fully hydrogenated | | | | | |
|---|---|---|---|---|---|---|
| | soybean oil (CIE) | | | | | |
| | Liquid oil | | | | | |
| | Soybean oil | | | Canola oil | | |
| | Liquid oil:Hardstock ratio | | | | | |
| | 50:50 | 60:40 | 70:30 | 50:50 | 60:40 | 70:30 |
| Fatty Acids | | | | | | |
| C12:0 | 0.0 | 0.0 | 0.0 | 0.0 | 0.0 | 0.0 |
| C14:0 | 0.1 | 0.0 | 0.1 | 0.1 | 0.1 | 0.1 |
| C16:0 | 11.3 | 10.9 | 10.8 | 7.8 | 7.0 | 6.7 |
| Total | 11.4 | 10.9 | 10.9 | 7.9 | 7.1 | 6.8 |
| C12:0-C16:0 | | | | | | |
| C18:0 | 21.3 | 17.9 | 14.5 | 20.1 | 16.3 | 12.7 |
| C18:1 t | 0.0 | 0.0 | 0.1 | 0.0 | 0.0 | 0.1 |
| C18:1 c | 18.0 | 19.2 | 20.6 | 38.2 | 43.4 | 44.6 |
| Total C18:1 | 18.0 | 19.2 | 20.7 | 38.2 | 43.4 | 44.7 |
| C18:2 t | 0.2 | 1.2 | 0.3 | 0.0 | 0.1 | 0.2 |
| C18:2 c | 42.9 | 45.0 | 46.2 | 25.7 | 24.3 | 24.4 |
| Total C18:2 | 43.1 | 46.2 | 46.5 | 25.7 | 24.4 | 24.6 |
| C18:3 t | 0.4 | 0.4 | 0.5 | 0.6 | 0.7 | 0.9 |
| C18:3 c | 5.1 | 5.3 | 5.7 | 6.5 | 7.0 | 7.6 |
| Total C18:3 | 5.5 | 5.7 | 6.2 | 7.1 | 7.7 | 8.5 |
| sats | 33.4 | 29.8 | 26.6 | 29.0 | 24.4 | 20.7 |
| monos | 18.1 | 19.3 | 20.7 | 38.3 | 43.5 | 44.7 |
| polys | 48.0 | 50.3 | 52.7 | 32.2 | 31.3 | 33.0 |
| trans | 0.5 | 0.6 | 1.0 | 0.6 | 0.8 | 1.2 |
| SFC Temp | SFC | SFC | SFC | SFC | SFC | SFC |
| 0.0° C. | 21.7 | 16.0 | 11.3 | 20.2 | 14.0 | 9.5 |
| 10.0° C. | 11.0 | 11.9 | 8.7 | 16.2 | 12.5 | 9.7 |
| 15.6° C. | 14.8 | 13.5 | 9.4 | 18.5 | 13.5 | 9.9 |
| 21.1° C. | 14.8 | 10.4 | 6.2 | 15.0 | 10.5 | 7.1 |
| 26.7° C. | 9.2 | 7.4 | 4.2 | 9.4 | 6.2 | 4.5 |
| 33.3° C. | 5.9 | 5.0 | 2.7 | 5.5 | 4.0 | 2.6 |
| 37.8° C. | 3.8 | 3.4 | 1.9 | 3.8 | 3.0 | 1.8 |
| 40.0° C. | 3.2 | 2.7 | 1.3 | 2.9 | 2.1 | 1.3 |
| 42.5° C. | 2.4 | 1.9 | 0.5 | 2.1 | 1.4 | 1.0 |
| 45.0° C. | 1.5 | 0.9 | 0.0 | 1.3 | 0.5 | 0.5 |
| 47.5° C. | 0.6 | 0.0 | | 0.9 | 0.0 | 0.0 |
| 50.0° C. | 0.0 | | | 0.0 | | |

### Example 3

The 60% canola oil: 40% fully hydrogenated soybean oil chemically interesterified hardstock of Example 1 was diluted separately with soybean oil and liquid canola oil to provide six samples as follows: 50:50 (liquid:hardstock), 60:40 (liquid:hardstock), and 70:30 (liquid:hardstock). The fatty acid profile and SFC data were measured as described in Example 1 and the data is presented in Table 4 below.

TABLE 4

| | Hardstock = 60% canola oil:40% fully hydrogenated | | | | | |
|---|---|---|---|---|---|---|
| | soybean oil (CIE) | | | | | |
| | Liquid oil | | | | | |
| | Soybean oil | | | Canola oil | | |
| | Liquid oil:Hardstock ratio | | | | | |
| | 50:50 | 60:40 | 70:30 | 50:50 | 60:40 | 70:30 |
| Fatty Acids | | | | | | |
| C12:0 | 0.1 | 0.1 | 0.0 | 0.0 | 0.0 | 0.1 |
| C14:0 | 0.1 | 0.1 | 0.1 | 0.1 | 0.1 | 0.1 |
| C16:0 | 9.3 | 9.5 | 9.7 | 5.9 | 5.5 | 5.6 |
| Total C12:0-C16:0 | 9.5 | 9.7 | 9.8 | 6.0 | 5.6 | 5.7 |
| C18:0 | 20.5 | 16.8 | 14.0 | 19.2 | 15.7 | 12.2 |
| C18:1 t | 0.0 | 0.0 | 0.1 | 0.0 | 0.0 | 0.1 |
| C18:1 c | 29.6 | 28.8 | 27.4 | 49.9 | 52.7 | 51.4 |
| Total C18:1 | 29.6 | 28.8 | 27.5 | 49.9 | 52.7 | 51.5 |
| C18:2 t | 0.0 | 0.2 | 0.3 | 0.1 | 0.2 | 0.2 |
| C18:2 c | 33.0 | 37.1 | 40.4 | 15.6 | 16.2 | 18.7 |
| Total C18:2 | 33.0 | 37.3 | 40.7 | 15.7 | 16.4 | 18.9 |
| C18:3 t | 0.4 | 0.4 | 0.5 | 0.6 | 0.7 | 0.9 |
| C18:3 c | 5.8 | 5.9 | 5.9 | 7.3 | 7.6 | 7.8 |
| Total C18:3 | 6.2 | 6.3 | 6.4 | 7.9 | 8.3 | 8.7 |
| sats | 31.1 | 27.6 | 23.8 | 26.3 | 22.5 | 17.9 |
| monos | 29.7 | 28.9 | 27.5 | 50.0 | 52.9 | 51.5 |
| polys | 38.8 | 43.0 | 47.2 | 23.0 | 23.8 | 27.5 |
| trans | 0.5 | 0.6 | 1.0 | 0.7 | 0.9 | 1.2 |
| SFC Temp | SFC | SFC | SFC | SFC | SFC | SFC |
| 0.0° C. | 17.9 | 13.2 | 8.9 | 17.4 | 12.4 | 8.8 |
| 10.0° C. | 17.5 | 14.1 | 10.6 | 19.3 | 15.6 | 11.0 |
| 15.6° C. | 18.0 | 14.3 | 9.4 | 18.3 | 13.6 | 8.7 |
| 21.1° C. | 13.5 | 10.0 | 6.1 | 12.8 | 9.0 | 5.8 |
| 26.7° C. | 8.5 | 6.3 | 4.2 | 8.1 | 5.6 | 3.3 |
| 33.3° C. | 4.8 | 3.8 | 2.5 | 4.4 | 3.0 | 1.4 |
| 37.8° C. | 2.8 | 2.3 | 1.1 | 2.7 | 1.9 | 0.7 |
| 40.0° C. | 2.0 | 1.7 | 0.5 | 2.0 | 1.3 | 0.4 |
| 42.5° C. | 1.1 | 1.1 | 0.0 | 1.4 | 0.8 | 0.0 |
| 45.0° C. | 0.7 | 0.5 | | 0.8 | 0.0 | |
| 47.5° C. | 0.4 | 0.0 | | 0.4 | | |
| 50.0° C. | 0.0 | | | 0.0 | | |

### Example 4

The 60% soybean oil: 40% fully hydrogenated soybean oil enzymatically interesterified hardstock of Example 1 was diluted separately with soybean oil and canola oil to provide six samples as follows: 50:50 (liquid:hardstock), 60:40 (liquid:hardstock), and 70:30 (liquid:hardstock). The fatty acid profile and SFC data were measured as described in Example 1 and the data is presented in Table 5 below.

TABLE 5

| | Hardstock = 60% soybean oil:40% fully | | | | | |
|---|---|---|---|---|---|---|
| | hydrogenated soybean oil (EIE) | | | | | |
| | Liquid oil | | | | | |
| | Soybean oil | | | Canola Oil | | |
| | Liquid oil:hardstock ratio | | | | | |
| | 50:50 | 60:40 | 70:30 | 50:50 | 60:40 | 70:30 |
| Fatty Acids | | | | | | |
| C12:0 | 0.0 | 0.0 | 0.0 | 0.0 | 0.0 | 0.0 |
| C14:0 | 0.1 | 0.1 | 0.1 | 0.1 | 0.1 | 0.1 |
| C16:0 | 10.9 | 10.8 | 10.8 | 7.9 | 7.3 | 6.6 |
| Total C12:0-C16:0 | 11.0 | 10.9 | 10.9 | 8.0 | 7.4 | 6.7 |
| C18:0 | 20.5 | 17.3 | 14.1 | 19.2 | 15.7 | 12.3 |
| C18:1 t | 0.4 | 0.3 | 0.3 | 0.4 | 0.3 | 0.3 |
| C18:1 c | 19.3 | 20.2 | 21.1 | 36.5 | 40.8 | 45.1 |
| Total C18:1 | 19.7 | 20.5 | 21.4 | 36.9 | 41.1 | 45.4 |
| C18:2 t | 0.4 | 0.4 | 0.4 | 0.3 | 0.3 | 0.3 |
| C18:2 c | 42.2 | 44.2 | 46.3 | 26.7 | 25.6 | 24.5 |
| Total C18:2 | 42.6 | 44.6 | 46.7 | 27.0 | 25.9 | 24.8 |
| C18:3 t | 0.5 | 0.5 | 0.5 | 0.8 | 0.8 | 0.9 |
| C18:3 c | 4.7 | 5.0 | 5.3 | 6.1 | 6.6 | 7.2 |
| Total C18:3 | 5.2 | 5.5 | 5.8 | 6.9 | 7.4 | 8.1 |
| sats | 31.4 | 28.2 | 24.9 | 27.2 | 23.1 | 19.0 |
| monos | 19.7 | 20.5 | 21.4 | 36.9 | 41.1 | 45.4 |
| polys | 47.8 | 50.2 | 52.6 | 33.8 | 33.3 | 32.9 |
| trans | 1.3 | 1.2 | 1.2 | 1.4 | 1.4 | 1.4 |
| SFC Temp | SFC | SFC | SFC | SFC | SFC | SFC |
| 0.0° C. | 18.5 | 14.5 | 10.1 | 18.6 | 13.3 | 10.2 |
| 10.0° C. | 17.2 | 13.6 | 11.0 | 18.7 | 15.7 | 11.2 |
| 15.6° C. | 21.0 | 16.1 | 12.3 | 21.3 | 15.6 | 11.1 |
| 21.1° C. | 17.6 | 13.6 | 9.7 | 18.6 | 12.3 | 9.7 |
| 26.7° C. | 13.8 | 10.6 | 8.1 | 15.8 | 11.4 | 7.8 |
| 33.3° C. | 9.8 | 8.1 | 5.7 | 12.5 | 8.2 | 5.2 |
| 37.8° C. | 7.8 | 6.3 | 4.7 | 10.0 | 6.8 | 4.0 |
| 40.0° C. | 6.9 | 5.2 | 4.0 | 8.7 | 6.0 | 3.4 |
| 42.5° C. | 6.0 | 4.2 | 3.1 | 7.7 | 5.0 | 3.0 |
| 45.0° C. | 4.7 | 3.2 | 2.2 | 6.6 | 3.9 | 2.6 |
| 47.5° C. | 3.4 | 2.6 | 1.6 | 5.0 | 3.0 | 2.0 |
| 50.0° C. | 2.6 | 1.8 | 0.9 | 3.8 | 2.1 | 1.0 |
| 52.5° C. | 1.2 | 0.8 | 0.0 | 2.6 | 0.8 | 0.7 |
| 55.0° C. | 0.0 | 0.0 | | 1.0 | 0.0 | 0.0 |
| 57.5° C. | | | | 0.0 | | |

### Example 5

The 60% canola oil: 40% fully hydrogenated soybean oil enzymatically interesterified hardstock of Example 1 was diluted separately with liquid soybean oil and canola oil as follows: 50:50 (liquid:hardstock), 60:40 (liquid:hardstock), and 70:30 (liquid:hardstock) to provide six samples. The fatty acid profile and SFC data were measured as described in Example 1. The fatty acid profile and SFC data for the six samples are shown in Table 6 below.

TABLE 6

| | Hardstock = 60% canola oil:40% fully hydrogenated | | | | | |
|---|---|---|---|---|---|---|
| | soybean oil (EIE) | | | | | |
| | Liquid oil | | | | | |
| | Soybean oil | | | Canola Oil | | |
| | Liquid oil:hardstock ratio | | | | | |
| | 50:50 | 60:40 | 70:30 | 50:50 | 60:40 | 70:30 |
| Fatty Acids | | | | | | |
| C12:0 | 0.0 | 0.0 | 0.0 | 0.0 | 0.0 | 0.0 |
| C14:0 | 0.1 | 0.1 | 0.1 | 0.1 | 0.1 | 0.1 |
| C16:0 | 9.0 | 9.3 | 9.6 | 6.1 | 5.8 | 5.5 |
| Total | 9.1 | 9.4 | 9.7 | 6.2 | 5.9 | 5.6 |
| C12:0-C16:0 | | | | | | |
| C18:0 | 20.1 | 17.0 | 13.9 | 18.8 | 15.4 | 12.0 |
| C18:1 t | 0.3 | 0.3 | 0.2 | 0.3 | 0.3 | 0.2 |
| C18:1 c | 30.4 | 29.0 | 27.7 | 47.5 | 49.6 | 51.7 |
| Total C18:1 | 30.7 | 29.3 | 27.9 | 47.8 | 49.9 | 51.9 |
| C18:2 t | 0.3 | 0.3 | 0.3 | 0.2 | 0.2 | 0.2 |
| C18:2 c | 32.2 | 36.2 | 40.3 | 16.6 | 17.5 | 18.5 |
| Total C18:2 | 32.5 | 36.5 | 40.6 | 16.8 | 17.7 | 18.7 |
| C18:3 t | 0.5 | 0.5 | 0.5 | 0.8 | 0.8 | 0.9 |
| C18:3 c | 5.6 | 5.7 | 5.9 | 7.0 | 7.4 | 7.8 |
| Total C18:3 t | 6.1 | 6.2 | 6.4 | 7.8 | 8.2 | 8.7 |
| sats | 29.2 | 26.4 | 23.6 | 25.0 | 21.3 | 17.7 |
| monos | 30.7 | 29.3 | 27.9 | 47.8 | 49.9 | 51.9 |
| polys | 38.5 | 42.7 | 47.0 | 24.5 | 25.9 | 27.3 |
| trans | 1.1 | 1.1 | 1.1 | 1.2 | 1.2 | 1.3 |
| SFC Temp | SFC | SFC | SFC | SFC | SFC | SFC |
| 0.0° C. | 17.8 | 13.5 | 9.9 | 19.9 | 16.5 | 13.0 |
| 10.0° C. | 21.0 | 16.8 | 12.1 | 23.1 | 18.0 | 12.8 |
| 15.6° C. | 20.4 | 16.4 | 11.7 | 20.2 | 15.7 | 11.0 |
| 21.1° C. | 16.8 | 12.8 | 8.8 | 16.6 | 12.5 | 9.0 |
| 26.7° C. | 13.0 | 9.7 | 6.5 | 12.4 | 9.4 | 6.7 |
| 33.3° C. | 8.8 | 6.3 | 4.7 | 8.4 | 6.5 | 4.4 |
| 37.8° C. | 7.0 | 4.9 | 3.3 | 6.4 | 4.8 | 3.3 |
| 40.0° C. | 6.1 | 4.3 | 2.6 | 5.3 | 4.0 | 2.5 |
| 42.5° C. | 5.2 | 3.6 | 2.0 | 4.4 | 3.2 | 2.1 |
| 45.0° C. | 4.3 | 2.7 | 1.4 | 3.6 | 2.6 | 1.6 |
| 47.5° C. | 3.3 | 1.8 | 0.8 | 2.6 | 2.0 | 1.1 |
| 50.0° C. | 2.3 | 0.9 | 0.0 | 1.6 | 1.0 | 0.5 |
| 52.5° C. | 1.1 | 0.0 | | 1.0 | 0.4 | 0.0 |
| 55.0° C. | 0.0 | | | 0.0 | 0.0 | |

### Example 6

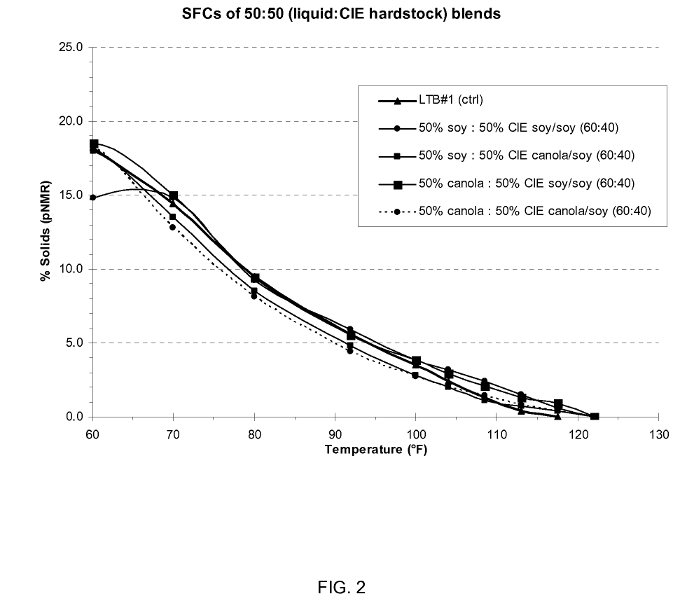

The four 50:50 diluted blends prepared according to Examples 2 and 3 (separately blending the chemically interesterified hardstocks with liquid soybean oil and canola oil) were chosen for further testing because their SFC curves (which partially define functionality) were close to the LTB#1 control as shown in Table 7 below and in FIG. 2.

TABLE 7

| | | | | 50% | 50% | 50% |
|---|---|---|---|---|---|---|
| | | | | liquid | liquid | liquid |
| | | | 50% liquid | SBO:50% | CAN:50% | CAN:50% |
| | | | SBO:50% | CIE | CIE | CIE |
| | | | CIE | hardstock | hardstock | hardstock |
| | | | hardstock | (60% | (60% | (60% |
| | | | (60% liquid | liquid | liquid | liquid |
| | | LTB#1 | SBO:40% | CAN:40% | CAN:40% | SBO:40% |
| ° C. | ° F. | (ctrl) | FHSBO) | FHSBO) | FHSBO) | FHSBO) |
| 0.0 | 32 | 23.6 | 21.7 | 17.9 | 17.4 | 20.2 |
| 10.0 | 50 | 21.7 | 11.0 | 17.5 | 19.3 | 16.2 |
| 15.6 | 60 | 18.2 | 14.8 | 18.0 | 18.3 | 18.5 |
| 21.1 | 70 | 14.4 | 14.8 | 13.5 | 12.8 | 15.0 |
| 26.7 | 80 | 9.5 | 9.2 | 8.5 | 8.1 | 9.4 |
| 33.3 | 92 | 5.6 | 5.9 | 4.8 | 4.4 | 5.5 |
| 37.8 | 100 | 3.5 | 3.8 | 2.8 | 2.7 | 3.8 |
| 40.0 | 104 | 2.4 | 3.2 | 2.0 | 2.0 | 2.9 |
| 42.5 | 109 | 1.3 | 2.4 | 1.1 | 1.4 | 2.1 |
| 45.0 | 113 | 0.4 | 1.5 | 0.7 | 0.8 | 1.3 |
| 47.5 | 118 | 0.0 | 0.6 | 0.4 | 0.4 | 0.9 |
| 50.0 | 122 | | 0.0 | 0.0 | 0.0 | 0.0 |
| 52.5 | 127 | | | | | |
| 55.0 | 131 | | | | | |

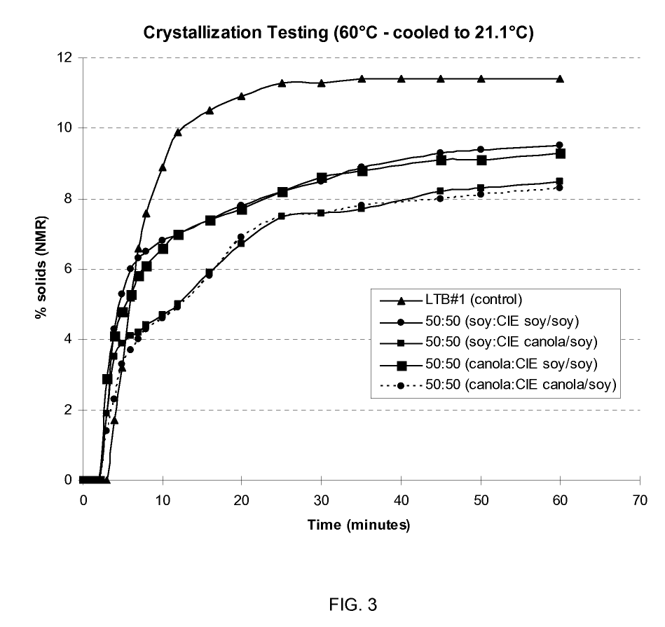

Crystallization testing was conducted on the four experimental samples and the LTB#1 control sample. The samples were placed in separate NMR tubes. The tubes were heated to 60° C. to completely melt the sample and destroy all fat crystal memory. The tubes were then transferred to heating blocks at 21.1° C. Solid fat readings were taken using a pulsed NMR every minute for the first 10 minutes, then every two minutes for the next 10 minutes, and then every five minutes for the remaining 40 minutes for a total of one hour. The crystallization test shows the rate of crystallization (i.e., development of fat solids) over time at various constant temperatures. This test demonstrated that, despite having the same relative amount of saturates plus trans as the LTB#1 control, all four blends began crystallizing faster than the control. The results of the crystallization test are presented in FIG. 3 and Table 8 below.

TABLE 8

| | | 50% | 50% | 50% | 50% |
|---|---|---|---|---|---|
| | | SBO:50% | SBO:50% | CAN:50% | CAN:50% |
| | | CIE | CIE | CIE | CIE |
| | | hardstock | hardstock | hardstock | hardstock |
| | | (60% | (60% | (60% | (60% |
| time | LTB#1 | SBO:40% | CAN:40% | CAN:40% | SBO:40% |
| (mins) | (control) | FHSBO) | FHSBO) | FHSBO) | FHSBO) |
| 0 | 0.0 | 0.0 | 0.0 | 0.0 | 0.0 |
| 1 | 0.0 | 0.0 | 0.0 | 0.0 | 0.0 |
| 2 | 0.0 | 0.0 | 0.0 | 0.0 | 0.0 |
| 3 | 0.0 | 1.9 | 1.9 | 1.4 | 2.9 |
| 4 | 1.7 | 4.3 | 3.5 | 2.3 | 4.1 |
| 5 | 3.2 | 5.3 | 3.9 | 3.3 | 4.8 |
| 6 | 5.2 | 6.0 | 4.1 | 3.7 | 5.3 |
| 7 | 6.6 | 6.3 | 4.2 | 4.0 | 5.8 |
| 8 | 7.6 | 6.5 | 4.4 | 4.3 | 6.1 |
| 10 | 8.9 | 6.8 | 4.7 | 4.6 | 6.6 |
| 12 | 9.9 | 7.0 | 5.0 | 4.9 | 7.0 |
| 16 | 10.5 | 7.4 | 5.9 | 5.8 | 7.4 |
| 20 | 10.9 | 7.8 | 6.7 | 6.9 | 7.7 |
| 25 | 11.3 | 8.2 | 7.5 | 7.5 | 8.2 |
| 30 | 11.3 | 8.5 | 7.6 | 7.6 | 8.6 |
| 35 | 11.4 | 8.9 | 7.7 | 7.8 | 8.8 |
| 40 | 11.4 | — | — | — | — |
| 45 | 11.4 | 9.3 | 8.2 | 8.0 | 9.1 |
| 50 | 11.4 | 9.4 | 8.3 | 8.1 | 9.1 |
| 60 | 11.4 | 9.5 | 8.5 | 8.3 | 9.3 |

### Example 7

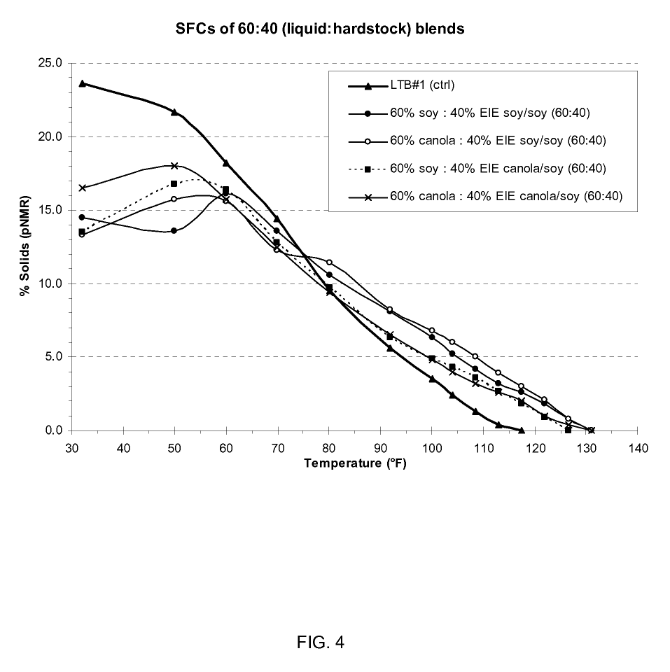

The four 60:40 diluted blends prepared according to Examples 4 and 5 using either liquid soybean oil or canola oil as diluents with the enzymatically interesterified hardstocks were selected for further testing. The SFC data for the four blends and LTB#1 control are presented below in Table 9 and in FIG. 4.

TABLE 9

| | | | | 60% | 60% |
|---|---|---|---|---|---|
| | | 60% SBO:40% | 60% CAN:40% | SBO:40% | CAN:40% |
| | | EIE | EIE | EIE | EIE |
| | | hardstock | hardstock | hardstock | hardstock |
| | | (60% | (60% | (60% | (60% |
| | LTB#1 | SBO:40% | SBO:40% | CAN:40% | CAN:40% |
| ° C. | (ctrl) | FHSBO) | FHSBO) | FHSBO) | FHSBO) |
| 0.0 | 23.6 | 14.5 | 13.3 | 13.5 | 16.5 |
| 10.0 | 21.7 | 13.6 | 15.7 | 16.8 | 18.0 |
| 15.6 | 18.2 | 16.1 | 15.6 | 16.4 | 15.7 |
| 21.1 | 14.4 | 13.6 | 12.3 | 12.8 | 12.5 |
| 26.7 | 9.5 | 10.6 | 11.4 | 9.7 | 9.4 |
| 33.3 | 5.6 | 8.1 | 8.2 | 6.3 | 6.5 |
| 37.8 | 3.5 | 6.3 | 6.8 | 4.9 | 4.8 |
| 40.0 | 2.4 | 5.2 | 6.0 | 4.3 | 4.0 |
| 42.5 | 1.3 | 4.2 | 5.0 | 3.6 | 3.2 |
| 45.0 | 0.4 | 3.2 | 3.9 | 2.7 | 2.6 |
| 47.5 | 0.0 | 2.6 | 3.0 | 1.8 | 2.0 |
| 50.0 | | 1.8 | 2.1 | 0.9 | 1.0 |
| 52.5 | | 0.8 | 0.8 | 0.0 | 0.4 |
| 55.0 | | 0.0 | 0.0 | | 0.0 |
| 57.5 | | | | | |
| 60.0 | | | | | |

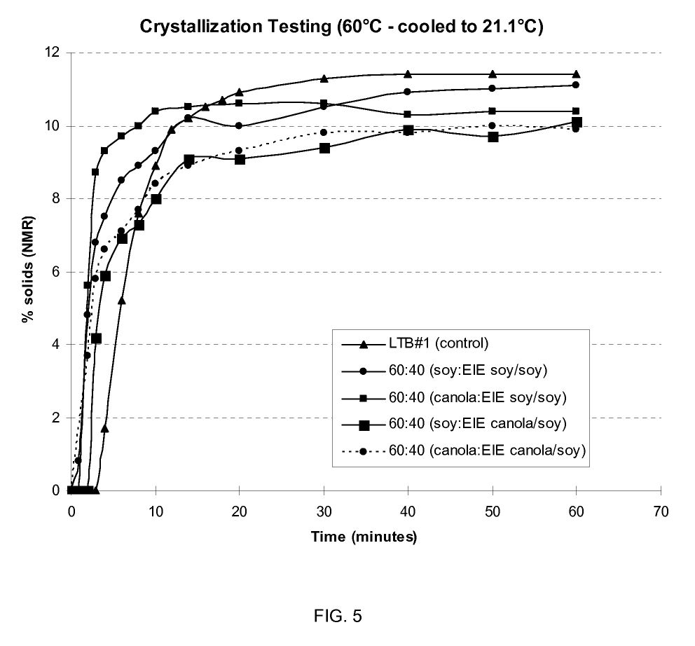

Crystallization testing was conducted on these samples (along with the control) as described in Example 6. These tests showed that, despite having less saturates+trans than the LTB#1 control, all four liquid oil:EIE hardstock blends began crystallizing faster than the control. The results of the crystallization test are presented in FIG. 5 and Table 10 below. Also, after an hour, these samples had achieved virtually the same total solids as the LTB#1 control.

TABLE 10

| | | 60% | 60% | 60% | 60% |
|---|---|---|---|---|---|
| | | SBO:40% | CAN:40% | SBO:40% | CAN:40% |
| | | EIE | EIE | EIE | EIE |
| | | hardstock | hardstock | hardstock | hardstock |
| | | (60% | (60% | (60% | (60% |
| time | LTB#1 | SBO:40% | SBO:40% | CAN:40% | CAN:40% |
| (mins) | (control) | FHSBO) | FHSBO) | FHSBO) | FHSBO) |
| 0 | 0.0 | 0.0 | 0.0 | 0.0 | 0.0 |
| 1 | 0.0 | 0.8 | 0.0 | 0.0 | |
| 2 | 0.0 | 4.8 | 5.6 | 0.0 | 3.7 |
| 3 | 0.0 | 6.8 | 8.7 | 4.2 | 5.8 |
| 4 | 1.7 | 7.5 | 9.3 | 5.9 | 6.6 |
| 6 | 5.2 | 8.5 | 9.7 | 6.9 | 7.1 |
| 8 | 7.6 | 8.9 | 10.0 | 7.3 | 7.7 |
| 10 | 8.9 | 9.3 | 10.4 | 8.0 | 8.4 |
| 12 | 9.9 | | | | |
| 14 | 10.2 | 10.2 | 10.5 | 9.1 | 8.9 |
| 16 | 10.5 | | | | |
| 18 | 10.7 | | | | |
| 20 | 10.9 | 10.0 | 10.6 | 9.1 | 9.3 |
| 30 | 11.3 | 10.5 | 10.6 | 9.4 | 9.8 |
| 40 | 11.4 | 10.9 | 10.3 | 9.9 | 9.8 |
| 50 | 11.4 | 11.0 | 10.4 | 9.7 | 10.0 |
| 60 | 11.4 | 11.1 | 10.4 | 10.1 | 9.9 |

### Example 8

Two samples of trans-free shortening were produced for pilot plant trials in Chips Ahoy!™ cookies. Sample 1 was a 60:40 blend of liquid canola oil and an enzymatically interesterified hardstock made from 60 percent liquid soybean oil and 40 percent fully hydrogenated soybean oil. Sample 2 was a 60:40 blend of liquid canola oil and an enzymatically interesterified hardstock made from 50 percent liquid soybean oil and 50 percent fully hydrogenated palm oil. Samples 1 and 2 both performed similar to the LTB#1 control. Both the control oil and experimental oils performed well in dough mixing, cookie forming, wire cutting, and baking operations. An informal taste panel sampled the control and test cookies and judged all products to be acceptable.

### Example 9

The fatty acid profiles and solid fat content curves of LTB#1 (Sample A) and two experimental samples were compared.

Two hardstock blends were produced. A 50:50 (liquid:solid) ratio hardstock using soybean oil as the liquid fraction and fully hydrogenated palm oil as the solid fraction was prepared by enzymatic interesterification. Liquid canola oil was used to dilute the resulting hardstock at a ratio of 60:40 to provide Sample B.

A 60:40 (liquid:solid) ratio hardstock using soybean oil as the liquid fraction and fully hydrogenated soybean oil as the solid fraction was prepared by enzymatic interesterification. Liquid canola oil was used to dilute the hardstock at a ratio of 60:40 to provide Sample C.

Table 10 below shows the fatty acid profiles and solid fat content curves for the LTB#1 control, as well as the interesterified blends containing the fully hydrogenated palm oil (Sample B) and the fully hydrogenated soybean oil (Sample C). The two experimental samples had acceptably low levels of trans fatty acids.

TABLE 11

| | | Sample B: | |
|---|---|---|---|
| | | 60% CAN:40% | |
| | | EIE | Sample C: |
| | Sample A: | hardstock (50% | 60% CAN:40% EIE |
| | LTB#1 | SBO:50% | hardstock (60% |
| Fatty Acids | (control) | FHPO) | SBO:40% FHSBO) |
| C12:0 | 0.0 | 0.2 | 0.0 |
| C14:0 | 0.2 | 0.3 | 0.1 |
| C16:0 | 12.7 | 14.0 | 7.3 |
| C18:0 | 10.0 | 12.0 | 15.6 |
| C18:1 trans/cis | 7.3/22.0 | 0.3/38.4 | 0.2/42.2 |
| C18:1 total | 29.3 | 38.7 | 42.4 |
| C18:2 trans/cis | 0.3/40.6 | 0.3/25.2 | 0.3/25.0 |
| C18:2 total | 40.9 | 25.5 | 25.3 |
| C18:3 trans/cis | 0.2/5.8 | 0.8/6.3 | 0.7/6.4 |
| C18:3 total | 6.0 | 7.1 | 7.1 |
| saturates | 23.8 | 27.5 | 23.9 |
| trans | 7.8 | 1.5 | 1.2 |
| SFC Temp | SFC (avg) | SFC (avg) | SFC (avg) |
| 0.0° C. (32° F.) | 24.0 | 23.8 | 13.8 |
| 10.0° C. (50° F.) | 22.3 | 23.3 | 14.2 |
| 15.6° C. (60° F.) | 18.5 | 17.8 | 15.4 |
| 21.1° C. (70° F.) | 14.1 | 13.6 | 12.5 |
| 26.7° C. (80° F.) | 10.0 | 9.8 | 9.8 |
| 33.3° C. (92° F.) | 5.3 | 6.0 | 6.7 |
| 37.8° C. (100° F.) | 2.5 | 3.4 | 5.1 |
| 40.0° C. (104° F.) | 1.3 | 2.6 | 4.3 |
| 42.5° C. (109° F.) | 0.0 | 1.2 | 3.8 |
| 45.0° C. (113° F.) | | 0.0 | 2.5 |
| 47.5° C. (118° F.) | | | 1.7 |
| 50.0° C. (122° F.) | | | 0.8 |
| 52.5° C. (127° F.) | | | 0.0 |

### Example 10

The LTB#1 control was further compared to four experimental blends, Samples 1-4.

Sample 1: A 60:40 (liquid:solid) ratio hardstock using soybean oil as the liquid fraction and fully hydrogenated soybean oil as the solid fraction was prepared by enzymatic interesterification. Liquid soybean oil was used to the dilute the resulting hardstock at a ratio of 60:40 to provide Sample 1.

Sample 2: A 60:40 ratio hardstock using soybean oil as the liquid fraction and fully hydrogenated soybean oil as the solid fraction was prepared by enzymatic interesterification. Liquid canola oil was used to the dilute the resulting hardstock at a ratio of 60:40 to provide Sample 2.

Sample 3: A 60:40 ratio hardstock using canola oil as the liquid fraction and fully hydrogenated soybean oil as the solid fraction was prepared by enzymatic interesterification. Liquid soybean oil was used to the dilute the resulting hardstock at a ratio of 60:40 to provide Sample 2.

Sample 4: A 60:40 ratio hardstock using canola oil as the liquid fraction and fully hydrogenated soybean oil as the solid fraction was prepared by enzymatic interesterification. Liquid canola oil was used to the dilute the resulting hardstock at a ratio of 60:40 to provide Sample 2.

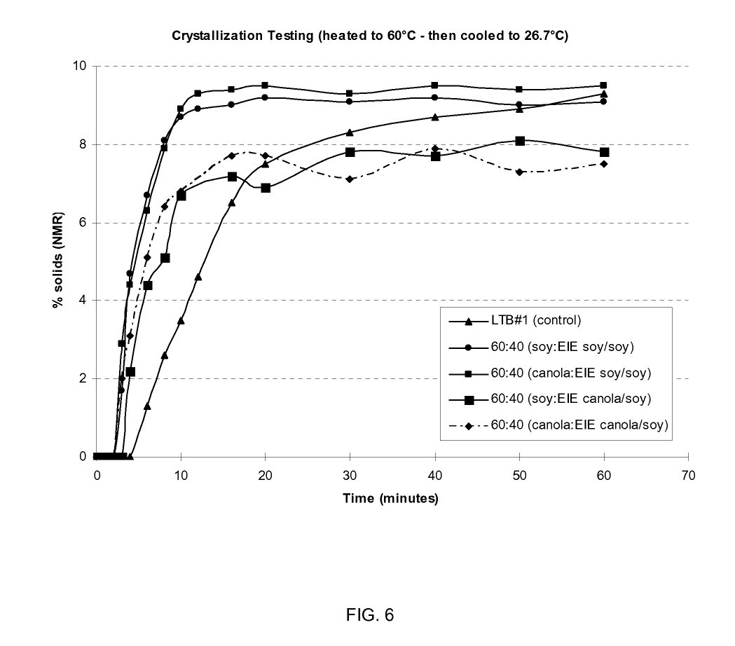

Crystallization testing was conducted on Samples 1-4 (along with the control) as described in Example 6 at 26.7° C., which is a typical bakery processing temperature. The results are presented below in Table 12 and in FIG. 6. The four interesterified shortenings surprisingly showed faster crystallization than the control and, advantageously, with less saturates.

TABLE 12

| | | Sample 1 | Sample 2 | Sample 3 | Sample 4 |
|---|---|---|---|---|---|
| | | 60% | 60% | 60% | 60% |
| | | SBO:40% | CAN:40% | SBO:40% | CAN:40% |
| | | EIE | EIE | EIE | EIE |
| | | hardstock | hardstock | hardstock | hardstock |
| Time | LTB#1 | (SBO/ | (SBO/ | (CAN/ | (CAN/ |
| (min) | (control) | FHSBO) | FHSBO) | FHSBO) | FHSBO) |
| 0 | 0.0 | 0.0 | 0.0 | 0.0 | 0.0 |
| 1 | 0.0 | 0.0 | 0.0 | 0.0 | 0.0 |
| 2 | 0.0 | 0.0 | 0.0 | 0.0 | 0.0 |
| 3 | 0.0 | 1.7 | 2.9 | 0.0 | 2.0 |
| 4 | 0.0 | 4.7 | 4.4 | 2.2 | 3.1 |
| 6 | 1.3 | 6.7 | 6.3 | 4.4 | 5.1 |
| 8 | 2.6 | 8.1 | 7.9 | 5.1 | 6.4 |
| 10 | 3.5 | 8.7 | 8.9 | 6.7 | 6.8 |
| 12 | 4.6 | 8.9 | 9.3 | | |
| | | | | 7.2 | 7.8 |
| 16 | 6.5 | 9.0 | 9.4 | 7.2 | 7.7 |
| 20 | 7.5 | 9.2 | 9.5 | 6.9 | 7.7 |
| 30 | 8.3 | 9.1 | 9.3 | 7.8 | 7.1 |
| 40 | 8.7 | 9.2 | 9.5 | 7.7 | 7.9 |
| 50 | 8.9 | 9.0 | 9.4 | 8.1 | 7.3 |
| 60 | 9.3 | 9.1 | 9.5 | 7.8 | 7.5 |

### Example 11

The crystallization rates of LTB#1 control were further compared to two experimental blends (Samples 1 and 2).

Sample 1: A 50:50 ratio hardstock using soybean oil as the liquid fraction and fully hydrogenated palm oil as the solid fraction was prepared by enzymatic interesterification. Liquid canola oil was used to dilute the hardstock at a ratio of 60:40.

Sample 2: A 60:40 ratio hardstock using soybean oil as the liquid fraction and fully hydrogenated soybean oil as the solid fraction was prepared by enzymatic interesterification. Liquid canola oil was used to dilute the hardstock at a ratio of 60:40.

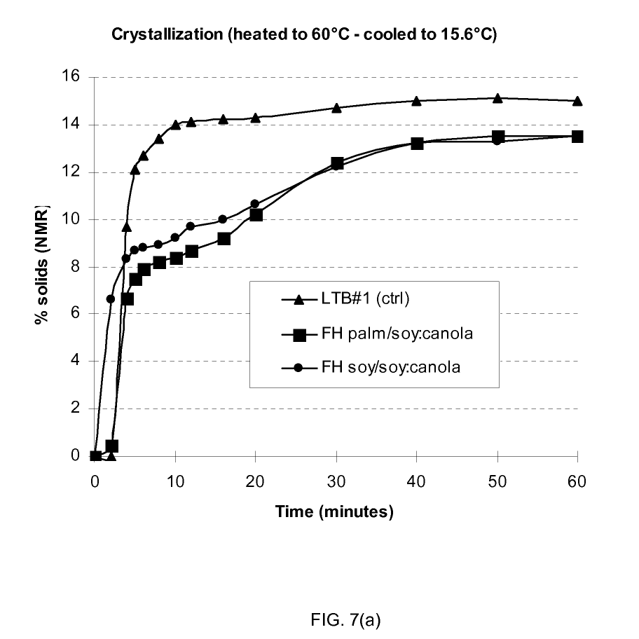

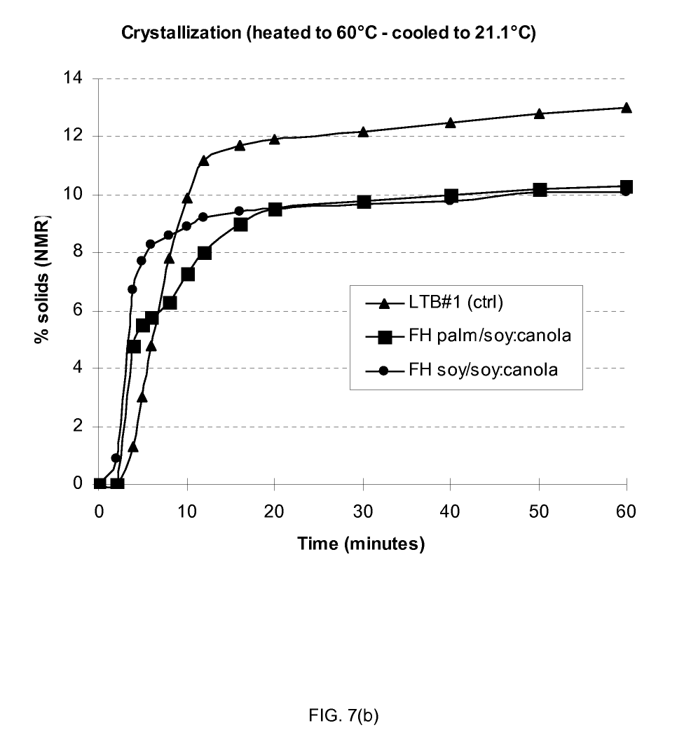

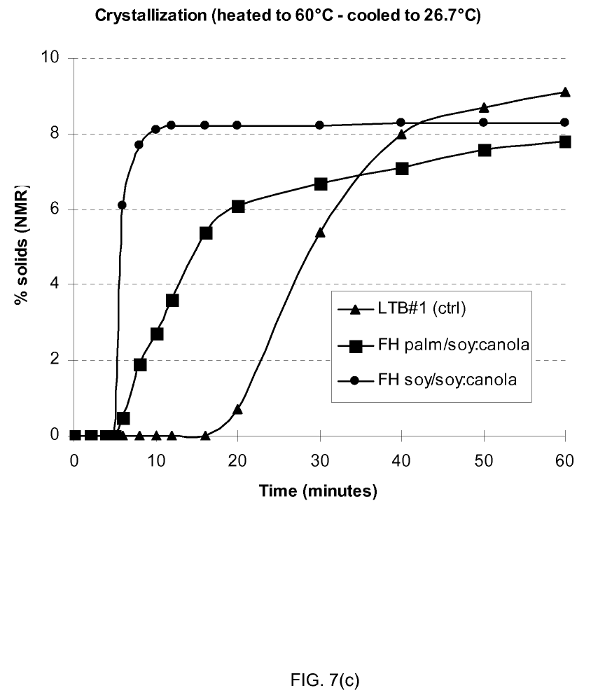

The crystallization rates for LTB#1 and Samples 1 and 2 were tested at 15.6, 21.1, and 26.7° C., the results of which are presented in Table 13 below and in FIGS. 7(a)-(c). The chart shows these rates at all 3 test temperatures (15.6, 21.1, and 26.7° C.).

TABLE 13

| | 15.6° C. | | | 21.1° C. | | | 26.7° C. | | |
|---|---|---|---|---|---|---|---|---|---|
| | | Sample 1 | Sample 2 | | Sample 1 | Sample 2 | | Sample 1 | Sample 2 |
| Time | LTB#1 | CAN:hardstock | CAN:hardstock | LTB#1 | CAN:hardstock | CAN:hardstock | LTB#1 | CAN:hardstock | CAN:hardstock |
| (min) | (ctrl) | (SBO:FHPO) | (SBO:FHSBO) | (ctrl) | (SBO:FHPO) | (SBO:FHSBO) | (ctrl) | (SBO:FHPO) | (SBO:FHSBO) |
| 0 | 0.0 | 0.0 | 0.0 | 0.0 | 0.0 | 0.0 | 0.0 | 0.0 | 0.0 |
| 2 | 0.0 | 0.5 | 6.6 | 0.0 | 0.0 | 0.9 | 0.0 | 0.0 | 0.0 |
| 4 | 9.7 | 6.7 | 8.3 | 1.3 | 4.8 | 6.7 | 0.0 | 0.0 | 0.0 |
| 5 | 12.1 | 7.5 | 8.7 | 3.0 | 5.5 | 7.7 | 0.0 | 0.0 | 0.0 |
| 6 | 12.7 | 7.9 | 8.8 | 4.8 | 5.8 | 8.3 | 0.0 | 0.5 | 6.1 |
| 8 | 13.4 | 8.2 | 8.9 | 7.8 | 6.3 | 8.6 | 0.0 | 1.9 | 7.7 |
| 10 | 14.0 | 8.4 | 9.2 | 9.9 | 7.3 | 8.9 | 0.0 | 2.7 | 8.1 |
| 12 | 14.1 | 8.7 | 9.7 | 11.2 | 8.0 | 9.2 | 0.0 | 3.6 | 8.2 |
| 16 | 14.2 | 9.2 | 10.0 | 11.7 | 9.0 | 9.4 | 0.0 | 5.4 | 8.2 |
| 20 | 14.3 | 10.2 | 10.6 | 11.9 | 9.5 | 9.5 | 0.7 | 6.1 | 8.2 |
| 30 | 14.7 | 12.4 | 12.2 | 12.2 | 9.8 | 9.7 | 5.4 | 6.7 | 8.2 |
| 40 | 15.0 | 13.2 | 13.2 | 12.5 | 10.0 | 9.8 | 8.0 | 7.1 | 8.3 |
| 50 | 15.1 | 13.5 | 13.3 | 12.8 | 10.2 | 10.1 | 8.7 | 7.6 | 8.3 |
| 60 | 15.0 | 13.5 | 13.5 | 13.0 | 10.3 | 10.1 | 9.1 | 7.8 | 8.3 |

Numerous modifications and variations in practice of the processes described herein are expected to occur to those skilled in the art upon consideration of the foregoing detailed description. Consequently, such modifications and variations are intended to be included within the scope of the following claims.

What is claimed is:

1. A method for preparing a functional oil blend, the method comprising:
combining liquid oil and fully hydrogenated vegetable oil in a ratio of about 70:30 to about 40:60 to provide a first oil mixture;
interesterifying the first oil mixture to provide a concentrated saturated fatty acid fraction; and
blending liquid vegetable oil with the concentrated saturated fatty acid fraction at a ratio of about 40:60 to about 75:25 to provide a no-trans oil blend having less than about 1.5 percent trans fatty acids, greater than 6 percent alpha-linolenic acid content, a ratio of linoleic acid to alpha-linolenic acid less than 10, and less than about 32 percent saturated fat, with less than 16 percent of C12:0, C14:0, and C16:0 saturated fatty acids derived from tropical oil.

2. The method of claim 1, wherein the liquid vegetable oil is combined with the concentrated saturated fatty acid fraction at a ratio of about 50:50 to about 70:30.

3. The method of claim 1, wherein liquid vegetable oil is combined with the concentrated saturated fatty acid fraction at a ratio of about 60:40.

4. The method of claim 1, wherein the liquid vegetable oil and fully hydrogenated vegetable oil are combined in a ratio of about 65:35 to about 45:55.

5. The method of claim 1, wherein the liquid vegetable oil and fully hydrogenated vegetable oil are combined in a ratio of about 60:40 to about 50:50.

6. The method of claim 1, wherein the vegetable oil combined with the fully hydrogenated vegetable oil is selected from the group consisting of soybean oil and canola oil.

7. The method of claim 1, wherein the fully hydrogenated vegetable oil is fully hydrogenated soybean oil.

8. The method of claim 1, wherein the vegetable oil combined with the concentrated saturated fatty acid fraction is selected from the group consisting of soybean oil and canola oil.

9. The method of claim 1, wherein interesterification is catalyzed enzymatically.

10. The method of claim 1, wherein interesterification is catalyzed chemically.

11. A functional oil blend comprising less than 1.5 percent trans fatty acids, greater than 6 percent alpha-linolenic acid, less than 32 percent saturated fatty acids where less than about 16 percent of C12:0, C14:0, and C16:0 saturated fatty acids are derived from tropical oil, and a ratio of linoleic acid to alpha-linolenic acid of less than 10.

12. The functional oil blend of claim 11, wherein the functional no trans blend is produced by a method comprising:
combining liquid oil and fully hydrogenated vegetable oil in a ratio of about 70:30 to about 40:60 to provide a first oil mixture;
interesterifying the first oil mixture to provide a concentrated saturated fatty acid fraction; and
blending liquid vegetable oil with the concentrated saturated fatty acid fraction at a ratio of about 40:60 to about 75:25 to provide a no-trans oil blend having less than about 1.5 percent trans fatty acids, greater than 6 percent alpha-linolenic acid content, a ratio of linoleic acid to alpha-linolenic acid less than 10, and less than about 32 percent saturated fat, with less than 16 percent of C12:0, C14:0, and C16:0 saturated fatty acids derived from tropical oil.

13. The functional oil blend of claim 11, wherein the functional no-trans oil blend comprises less than about 25 percent saturated fatty acids.

14. The functional oil blend of claim 11, wherein the functional no-trans oil blend comprises a ratio of linoleic acid to alpha-linolenic acid less than 7.

15. The functional oil blend of claim 11, wherein the functional no-trans oil blend comprises a ratio of linoleic acid to alpha-linolenic acid less than 4

16. A food product comprising the functional oil blend of claim 11.

17. The food product of claim 16, wherein the food product is selected from the group consisting of cookies and crackers.
